(19) United States
(12) Patent Application Publication
(10) Pub. No.: US 2005/0188007 A1
(43) Pub. Date: Aug. 25, 2005

(54) System and method for embedding data transmission in a web page

(76) Inventors: Rich Warner, Salt Lake City, UT (US); Thomas Wright, Salt Lake City, UT (US)

Correspondence Address: TRASK BRITT, P.O. BOX 2550, SALT LAKE CITY, UT, 84110, US

(21) Appl. No.: 10/785,124

(22) Filed: Feb. 24, 2004

(51) Int. Cl. G06F 15/16

(52) U.S. Cl. 709/203

(57) ABSTRACT

A system and method for embedding data transmission in a web page, enabling communication between a user and a representative includes requesting a web page which includes at least one nondisplay space object and at least one display space object which is configured to transmit data to and from a backend server without the necessity of refreshing the current page, redirection to another web page, or posting to another web page. The web page is rendered and includes at least one display space and at least one nondisplay space according to the display space object and the at least one nondisplay space object. The display space object may connect with the backend server to form a persistent communication channel to enable real-time communication, and/or it may transmit data through invisible HTTP/HTTPS requests, or both. A persistent communication channel may be initiated by the display space object, triggered by the end user, or initiated by the backend representative.

### BACKGROUND OF THE INVENTION

1. Field of the Invention

The present invention relates to the field of data transmission and, more particularly, to communication between a visitor to a web page and a backend system configured for use by, for example, service representatives and/or sales persons, facilitating lead generation, sales efforts, and/or customer support.

2. State of the Art

A variety of web pages on the Internet now carry spaces set apart for the display of certain content not necessarily native to the site, and often provided (and sometimes hosted) by a third-party, such as, for example, a space housing an advertisement, or content promoting a particular service on a site. Such spaces are referred to herein as “display spaces”. Conventionally, when an end user clicks on a display space on a web page, the end user terminal is connected to a server hosting the destination web content of the content provider for the space, and the server then enables an end user to view the content linked to the space at their terminal. Although an end user simply needs to click on a display space to receive display space-linked contents, the more times a user has to click to get to specific content, the greater the likelihood of losing the end user before they arrive. Furthermore, visitors are more and more reluctant to allow being redirected to unknown sites as site owners prefer to keep visitors on their own sites as much as possible. But when a company is advertising on another party's website, or providing, for example, communication tools to another party's website, it has heretofore been necessary to provide links to the destination functionality rather than embedding it directly in the other party's website, resulting in lower usage. Site owners often frown on presenting links and tools that will take visitors away from their web sites.

A display space object is a file or combination of files used to provide content to a display space, often with the purpose of drawing visitor attention, but usually in a manner that isn't intrusive to the primary functionality of the web page in which it resides. Common examples of such files include, but are not limited to, images (.jpg, .gif), HTML code, and Flash (.swf) files. Though they have commonly been used to display graphics, animation, and common HTML elements, objects used in display spaces have not traditionally held any capacity for resident processing and dynamic interactivity. Conventionally, they have been used as links that open up a new window or redirect a user to another web page or web site, or as forms that post to another web page or web site.

FIG. 1 illustrates a conventional display space object that deceptively appears to provide a submittable form. However, the display space object is just an image that, when clicked, links to an actual form on another web site. Such a configured advertisement entices a user to believe that the desired functionality is resident and the desired effect could be quickly obtained. There exist “Rich Media” display spaces that may contain HTML code and HTML forms but, since such code is contained in a display space and isn't native to the page, the housing pages don't hold the capacity for the dynamic interactivity and processing of the interaction with the HTML elements (such as sending information from a form to a database and displaying the result), so any application interaction (such as the posting of a form and the processing of the data contained therein) must happen as a result of redirection or posting to another web page or web site.

Other web sites give the appearance of integrated interaction by linking out to a tool on a separate web site. For example, if a web page could benefit from a form of “live chat”, the web page may place a button on the web page that links out to another chat service through an additional window or frame.

Additionally, when display spaces are used in lead generation and/or customer sales and support, there exists the problem that people have a natural resistance and/or timidity when it comes to asking for information or assistance. Others are unsure what their questions are, or are unaware that they're lacking important information. Yet others are simply hesitant to fill out web site forms or send their information electronically in other ways. In such cases, businesses may benefit from direct contact between these individuals and company representatives, especially if the visitor's contact information is obtained as a result. However, enticing customers and potential customers to initiate such contact presents a challenge to businesses offering these services online because of the anonymous and user-controlled navigational nature of the Internet.

### BRIEF SUMMARY OF THE INVENTION

The present invention is directed to a system and method for embedding data transmission, used for direct or indirect communication, in a web page. In one embodiment of the present invention, a method is provided for data transmission to take place between one or more display space objects and a backend server. A web page is requested and includes at least one nondisplay space object and at least one display space object which is configured to transmit data to and from the backend server via HTTP or HTTPS requests. The web page is rendered and includes at least one display space and at least one nondisplay space according to the at least one display space object and the at least one nondisplay space object. The backend server and the client interact via the HTTP or HTTPS requests which happen transparently to the user. The display space object presents the potentially dynamic, interactive interface to the user on the display space on the rendered web page, and data is transferred back and forth between the display space object and the backend server, without the necessity of refreshing the current page, redirection to another web page, or posting the current page or to another web page.

In another embodiment of the present invention, a method is provided real-time communication to take place between one or more display space objects and a backend server. A web page is requested and includes at least one nondisplay space object and at least one display space object which is configured to potentially initiate and maintain a persistent communication channel with a backend server. The web page is rendered and includes at least one display space and at least one nondisplay space according to the at least one display space object and the at least one nondisplay space object. The display space object may be configured to transmit data via HTTP and/or HTTPS requests as well as through a persistent communication channel. If configured to form a persistent communication channel, the display space object potentially initiates a secure (encrypted) or unsecure (unencrypted) connection with the backend server to form the persistent communication channel. The backend server and the client interact via the persistent communication channel. The display space object presents the potentially dynamic, interactive interface to the user on the display space on the rendered web page, and data is transferred back and forth in real-time between the display space object and the backend server, without the necessity of refreshing the current page, redirection to another web page, or posting the current page or to another web page.

In another embodiment of the present invention, a system is provided for communication to take place between a user and a representative. A web page is requested which includes at least one nondisplay space object and a at least one display space object, where at least one display space object is configured to initiate and maintain a persistent bidirectional communication channel with a backend server. The display space object in this embodiment may be configured to wait to initiate the connection only after the end user has interacted with the display space object in some specified way. It may also be configured to automatically initiate the connection. The system includes a backend server to which the display space object may connect via the persistent communication channel. The backend server is configured to allow for notification of a backend representative when the communication channel is established with the display space object. The system includes representative software persistently connected with the backend server and responsive to notification when the communication channel is established. The representative software is configured to communicate with the backend server in order that data may be transmitted real-time between the representative software and the display space object(s) via the backend server, and in order that such data may be presented in the interfaces of both the representative software and the display space object(s), without the necessity of page refreshes, redirection to another web page, or posting to another web page.

In a yet further embodiment of the present invention, a method is provided for a representative to approach a user over a network. A client requests a web page including at least one nondisplay space object and at least one display space object configured to be able to establish and maintain a communication channel with a backend server. The display space object potentially establishes and maintains a communication channel between the client and a backend server accessible to the representative through the representative software. The web page is rendered and includes at least one display space and at least one nondisplay space according to the at least one display space object and the at least one nondisplay-space object. The display space object makes its existence known to the backend server and potentially to the representative software, through the establishment of a persistent communication channel, or through HTTP or HTTPS requests. The persistent communication channel may be established at a specified time after the display space object initializes, or at the a data transmission indicates that that particular display space object has been flagged on the backend server for the establishment of a persistent communication channel. The representative may initiate real-time communication with the user viewing the display space object once a persistent communication channel has been established between the display space object and the backend server, and the user may communicate back with the representative through the display space object utilizing that channel. The user and representative interact over the persistent communication channel between the display space object and the backend server, to which the representative software is also connected. The communication happens without the necessity of page refreshes, redirection to another web page, or posting to another web page.

In yet a further embodiment of the present invention, a method is provided for two or more display space objects on a web page to communicate with each other. The web page is rendered and includes at least two display spaces and at least one nondisplay space according to the display space objects and the at least one nondisplay-space object. One or more of the display space objects may communicate with the backend server via HTTP or HTTPS request, or via a persistent communication channel. Furthermore, one or more of the display space objects may be configured to send and/or listen for method calls to and/or from other display space objects on the web page. Data may be shared between the display space objects on the page, without the necessity of page refreshes, redirection to another web page, or posting to another web page. The graphical user interfaces of the display objects may be altered accordingly.

### BRIEF DESCRIPTION OF THE SEVERAL VIEWS OF THE DRAWINGS

In the drawings, which illustrate what is currently considered to be the best mode for carrying out the invention:

FIG. 1 is a depiction of an advertising banner, in accordance with the prior art;

FIG. 2 illustrates a browser rendering of a web page, in accordance with an embodiment of the present invention;

FIG. 3 illustrates a web page with respective component objects, in accordance with an embodiment of the present invention;

FIG. 4 is a flowchart of an initialization of a persistent communication channel between an object embedded within a web page and a backend server, in accordance with an embodiment of the present invention;

FIG. 5 is a flowchart of method for a user-initiated interaction between an embedded object and a backend server, in accordance with an embodiment of the present invention;

FIG. 6 is a block diagram of a system for embedding communications within a web page, in accordance with an embodiment of the present invention;

FIG. 7 is a flowchart of a method for a backend representative-initiated interaction between an embedded object and a backend server, in accordance with an embodiment of the present invention;

FIG. 8 illustrates an exemplary interface of representative software, in accordance with an embodiment of the present invention;

FIG. 9 illustrates an exemplary interface of a real-time chat module of the representative software, in accordance with an embodiment of the present invention;

FIG. 10 illustrates an example of a display space object embedded in a web page as rendered by a browser, in accordance with an embodiment of the present invention;

FIG. 11 is a series of successive display contents for a visitor-initiated interaction between a site visitor and a representative through a display space object, in accordance with an embodiment of the present invention; and

FIG. 12 is a series of successive display contents for a representative-initiated interaction between a site visitor and a representative through a display space object, in accordance with an embodiment of the present invention.

### DETAILED DESCRIPTION OF THE INVENTION

The various embodiments of the present invention provide methods and systems for embedding direct and indirect communications (e.g., forms, live chat, voice, video, shared whiteboards, graphics, etc.) into a web page or into a web page's various elements (e.g., graphics, ad spaces, forms, calculators, etc.) where the transfer of data continues past when the, for example, HTTP request of the page as a whole has ended, and where the communication and/or transfer of information occurs transparently to the user from the web medium as opposed to with the refreshing of the page, or the redirection to, or opening of, or posting to, another web site or web page. The methods of direct and indirect communication are embedded into web pages that are retrieved and displayed such that interaction occurs directly from the web medium. The communication may be encrypted, for example, using SSL, or otherwise encrypted for security. There exists the ability, within this framework, for representatives of the site owner to initiate communication with visitors without any triggering required on the part of the visitor or user.

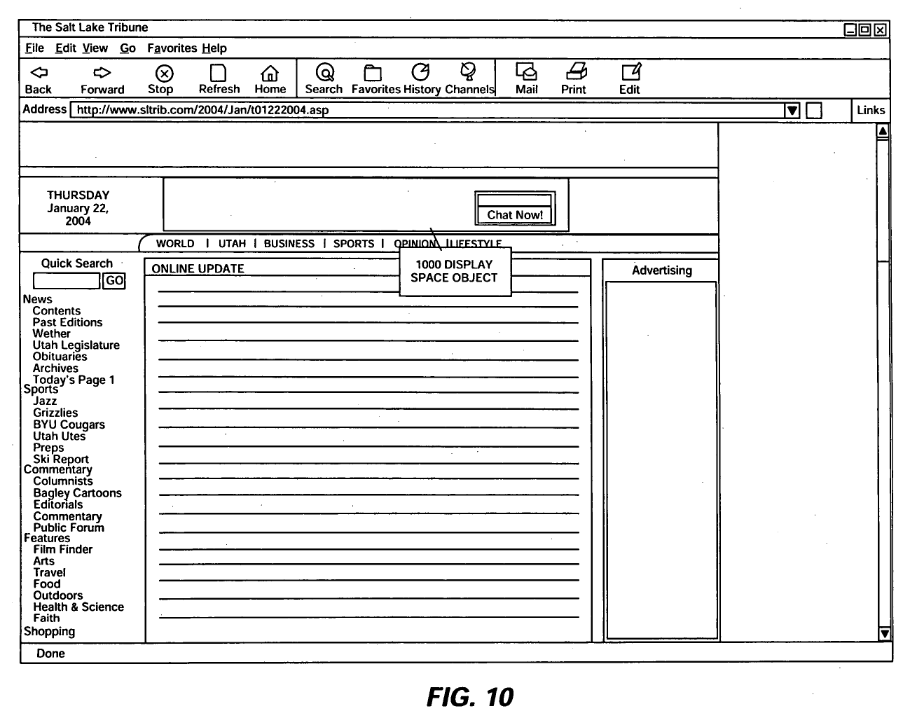

FIG. 2 is a diagram illustrating an example of a display space on a web page configured for facilitating communications from an object embedded therein, in accordance with an embodiment of the present invention. Similarly, FIG. 10 is a screenshot of an example demonstrating the use of a display space object on a web page configured to enable communication between a visitor and a representative, in accordance with an embodiment of the present invention. In one embodiment of the present invention, a web page 110 is requested from a server according to generally established principles. By way of example and not limitation, a web page 110 may include media pages such as multimedia pages comprised of one or more of text, graphics, sound and video. The web page 110 may be retrieved over a wide area network, an example of which is the World Wide Web which is also commonly referred to as the Internet. Access of web pages over the Internet utilizes hypertext links that allow a user at a client location to jump to one location on the Internet as specifically distinguished by a unique address, commonly referred to as a URL. The specific web pages are coded, according to one example, in a Hypertext Markup Language (“HTML”).

The exemplary network of the Internet is configured on a client/server model in which client software, an example and a portion of which is a “browser”, runs on the local computer while the server software runs on the web host. In an operational configuration after a connection to the network, for example the Internet, a browser 100 is launched and a URL identifying a specific web page is entered on the client by a user. The specific URL is sent in a URL request using, for example, HyperText Transfer Protocol (HTTP), which defines the communication protocol between the browser and the server. The URL request is sent to the Internet whereupon Internet routers examine the request to determine which server should receive the request. The server receives the request using, for example, the HTTP protocol. Once the requested web page is identified, the web page is sent back-to-back to the browser at the client. The browser 100 thereupon displays the web page 110 at the client and the HTTP connection is closed but may be reopened upon a subsequent request.

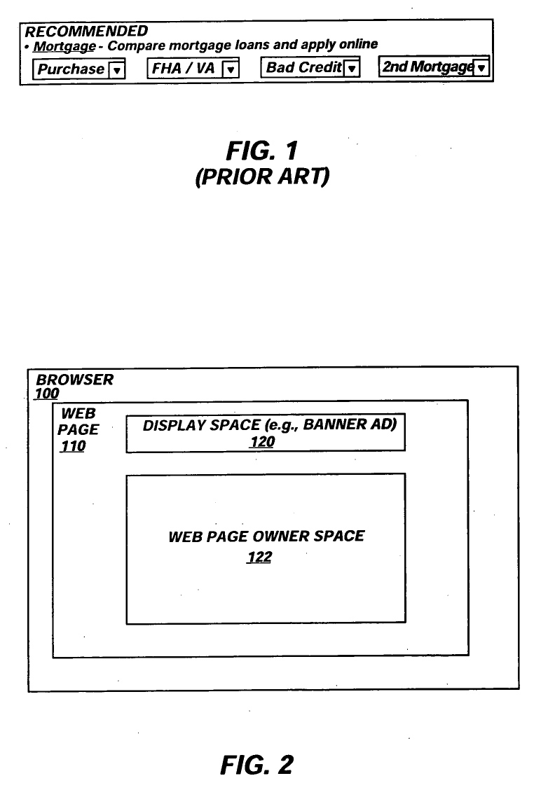

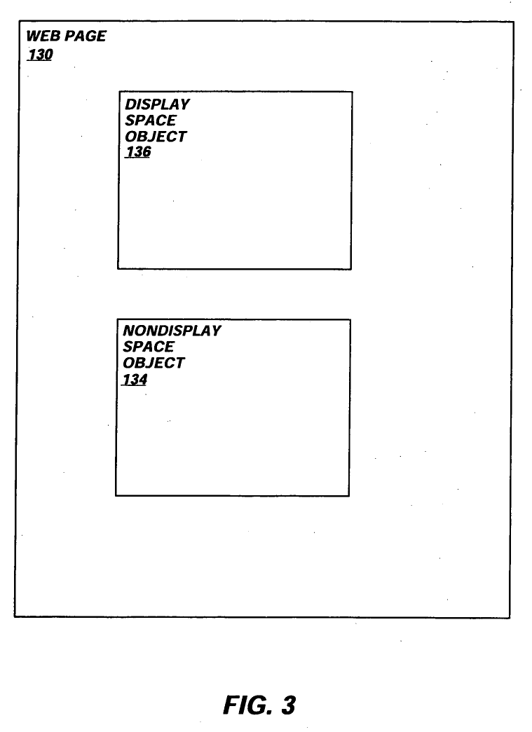

FIG. 3 is an object diagram illustrating the composition of a web page having an embedded display space object therein, in accordance with an embodiment of the present invention. A nonrendered web page 130 may be comprised of various content objects including text objects, image objects, video objects and audio objects, herein generally illustrated as nondisplay space objects 134. While these nondisplay space objects may be rendered and create visibly perceivable images, the term “nondisplay” is used to refer to objects associated specifically with the “display space” concepts of the various embodiments of the present invention. Nondisplay space objects are generally rendered by a browser as the respective forms of multimedia. The diagrammatically nonrendered web page 130, in accordance with an embodiment of the present invention, further comprises a display space object 136 which is configured, in one example as an ad configured to be rendered in a display space 120 (FIG. 1). The display space object may be configured to render, for example, as an ad on a web site, or it may occupy a display space on, for example, a real estate broker's web page or a retail company's web page. The display space object 136 may be provided by a third party to the web page owner to augment or advertise on the web page owner's web page 110 (FIG. 2), such as when the display space 120 (FIG. 2) is configured as an advertisement, an example of which is a banner ad. The display space object 136 is then downloaded to the client browser as part of the web page 130.

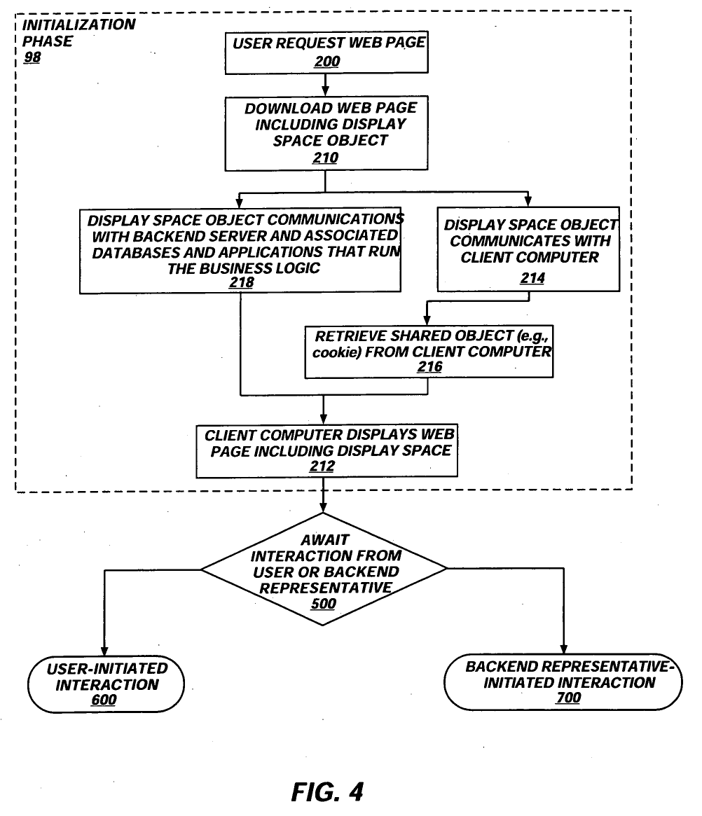

In accordance with one or more embodiments of the present invention, the method for communicating via a web page using embedded communication includes an initialization phase and an interaction phase. FIG. 4 is a flowchart of an initialization of a communication channel, in accordance with an embodiment of the present invention. In an initialization phase 98, a user requests 200 that a web page 110 (FIG. 2) be downloaded in accordance with the processes, for example, of a URL request as previously described. The user at the client that is requesting the web page need not be aware that the requested web page includes one or more embedded objects, herein defined as display space objects, as integrated therein. The requested web page including the embedded display space object(s) is downloaded 210 to the client and the HTTP request is terminated. When the object loads on the page, the display space object may look for a cookie, communicating 214 with the client to retrieve 216 any cookies previously placed with the client. Cookies are configured to store shared object information such as ID's (such as a user ID), status, preferences, and other information. One exemplary application for the use of cookies is to determine if the client has been on the web site previously, and if so, to use the user ID stored in the cookie to then retrieve further information about that visitor.

Furthermore, a display space object, as downloaded, may transmit data transparently 218 to the user between itself and and a backend server. The backend server includes databases, other data and business logic applications, and socket server software, generally referred to as the “backend.” Data transmission may be initiated by the display space object at the time it's downloaded (or at an interval thereafter), or upon triggering by the end user. The communication may take place through one or both of the following methods: (1) Separate HTTP or HTTPS requests that happen invisibly to the end user that transmit data to and from the backend server, and/or (2) a persistent encrypted or unencrypted bidirectional connection with the backend server socket software. One example of a module used to initiate, for example, invisible HTTP requests, includes a plug-in, an example of which is a Flash Player. The Flash Player is a plug-in (helper application) manufactured by Macromedia, Inc. of San Francisco, Calif., that allows an Internet browser to display high-quality, low-bandwidth, interactive, animated graphics. It also has the ability to make its own HTTP requests, and to establish a connection to a socket server. The Flash Player may be installed as an ActiveX® control or a Netscape® compatible browser plug-in depending upon the browser and operating system. For Windows® based computers using Microsoft® Internet Explorer®, the Flash Player may be an ActiveX® control. Under Netscape Navigator® and Netscape compatible browsers (for Macintosh®, Windows®, Linux and other devices) the Flash Player may be a plug-in. The Macromedia® Flash Player lets designers and developers integrate video, text, audio, and graphics into effective experiences. The Flash Player plays files of type .swf, which is a file type commonly accepted as safe, unobtrusive to the existent functionality of a web page, and acceptable for use in display spaces.

Additionally, one example of the socket server software includes the Macromedia Communication Server MX. Flash Communication Server MX is an enterprise-grade server technology that facilitates connections, for example, between the Flash 6 players, NET, and J2EE application servers and other Flash Communication Servers. In such a specific embodiment, an application that uses the resources of a communication server may be called a Flash Communication Application. Flash Communication Applications may be distributed over a local network or across the Internet using a traditional web server on a server platform (Macintosh, Unix, Windows). Applications are executed within Flash Player 6, independently, or embedded with a web browser that supports the Flash Player 6 plug-in.

The Flash Communication Server may be configured as a hub with Flash players connected to the hub using, for example, Macromedia's bidirectional communication protocol, for example, Real-Time Messaging Protocol (RTMP). As the hub, the Flash Communication Server may easily connect to other communication servers (hubs) to increase user and bandwidth capacity.

The connection happens between client-and-server or server-and-server which supports multiple one-way streams published or received by a client or the server. The Flash Communication Server includes a programming model called Shared Objects which synchronizes complex data and sends one-way messages between clients connected to the server. Regular ActionScript objects may be transported across network connections using, for example, the Action Message Format (AMF). This format is used over intermittent HTTP or secure intermittent HTTPS connections when exchanging data with application servers. The format is also used over the persistent RTMP connection when exchanging data between client and server. AMF is a binary format that is handled transparently by the server and Flash Player 6.

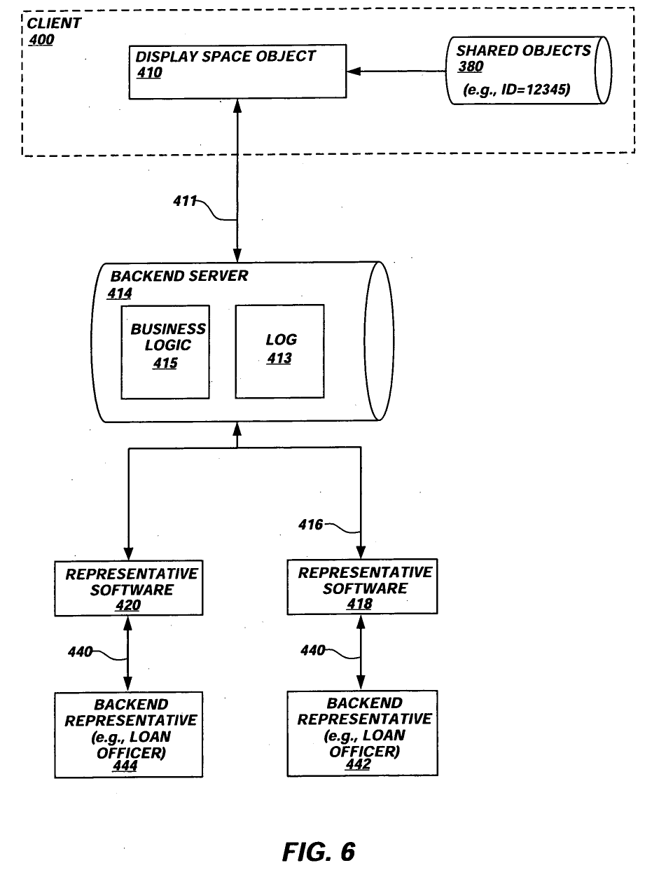

Any information retrieved from the cookie(s), such as user ID or other cookie-related information may be transmitted to the backend server for indexing and identification of the requesting client. Each display space object may have a unique identifier—whether in the form of an ID retrieved from a cookie identifying the user, or an ID generated at the time the display space object is downloaded, or an ID generated at the time a persistent connection is established between the display space object and the backend server socket software. The display space object may provide data collection forms that may also utilize either of the two methods to transmit data to and from the backend server. For example, in one or more embodiments of the present invention, the display space object collects a visitor's name before allowing him/her to communicate in real-time with a representative. Upon initialization, the display space object checks for any cookies containing the visitor's user ID. If found, it makes an invisible HTTP or HTTPS request to the backend server to send, for example, the ID and request that user's name. The name, for example, is sent in the HTTP or HTTPS response, and the display space object displays a message welcoming the user back, addressing him/her by name. In the case that a shared object is not found, the display space object may, for example, display a form asking, for example, for the visitor's name. At the time that a persistent connection is to be made with the backend server socket software, an inquiry may be sent to the backend server 415 (FIG. 6) to check the current number of connections and verify that there is an open slot to facilitate establishment of a communication channel according to the current display space object. If there is an open slot for the new display space object, then a communication channel may be created. When a slot is not available for an additional client, then optional content may be displayed by the display space object. Such optional content may be, for example, an application or information form where the visitor may fill out their contact information for contacting at a later time, or, for example, a message indicating that there will be a wait time before a slot is available. Additionally, the web page is rendered by the browser and displayed 212 according to the web page description as described by both the nondisplay space objects 134 (FIG. 3) and display space object 136 (FIG. 3).

The socket server software on the backend server maintains a persistent communication channel 411 (FIG. 6) between the display space object 410 (FIG. 6) and the representative software 420 (FIG. 6). The channel, in one embodiment, utilizes a TCP/IP protocol designed for high-performance transmission of audio, video, and data messages. The channel may support one-to-one, one-to-many, and many-to-many communications. Clients, which in this case may be the display space object or the representative software, connect to an instance of the socket server application and communicate over the persistent bidirectional connection that becomes established. Streams and shared objects allow clients to publish and play audio and video information and share data and text. Clients, in such an example, are in a constant listening state so that new transmissions are received in a timely manner. For example, the representative application allows a representative to instruct the display space object to redirect the browser to a new URL. The process is as follows: (1) The representative triggers the URL to be sent; (2) the representative software calls a method defined in the socket server software and passes the URL to the representative software; (3) the socket server software calls a method in the display space object and passes the URL to be opened; (4) the display space object opens the URL.

Furthermore, the business logic 415 resident on the backend server, in one embodiment, is configured to determine if backend representatives are available for communicating with a user at the client thus providing the user with real-time customer service or sales assistance via the established communication channel 411 (FIG. 6) with the display space object. The business logic that resides on the server may include methods such as those used to format visitor information and add it to the database, update such information, and retrieve such information. It also may include logic for storing and tracking interactions with visitors and may further include methods such as the one used to relay a URL to a display space object to be opened in the browser. Furthermore, the business logic may also include logic that, for example, communicates to the representative software to alert all representatives that a new visitor has established a connection. In the present specific example, the immediate availability of a backend representative for interacting with a user at the client could be discerned and appropriately responded to, for example, with the display space object at the client responding accordingly, such as (i) displaying an electronic form for filling-out by the user when a backend representative is unavailable or (ii) initiating of online chat between the backend representative and the user when the representative is available. The representative software may access data and logic on the backend server such as a previous interaction history between the representatives and the user for use by the backend representative in resuming interaction with the user in accordance with the retrieved history.

The initialization phase 98 begins with the rendering 121 of web page 110 (FIG. 2) (which includes both the display space 120 and web page space 122), and is completed when all the initialization tasks have run. According to the method of the present invention, processing then awaits 500 interaction from either the user or the backend representative. To this point, an interactive display space has been created for facilitating initiation and control of the interaction by either the user at the client or the backend representative. The display space 120 may be interacted with by either the user at the client and/or the backend representative (through the representative software) where communications are executed through text, voice, video, or image based “chat”, or through leading, for example the user, on a tour of other web pages desired to be shared with the other party, or any combination of these.

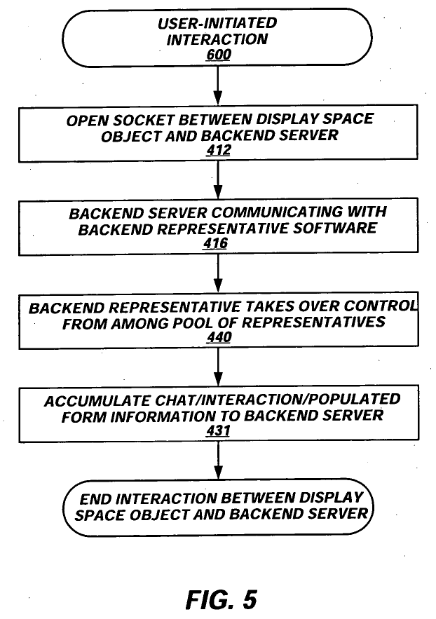

FIG. 5 illustrates interaction initiated by an end user, in accordance with an embodiment of the present invention. FIG. 6 is also referred to herein as a block diagram of a system for performing embedded communications, in accordance with an embodiment of the present invention. If interaction is initiated 600 by a user at the client, then a socket is opened 412 between the display space object 410 of client 400 and a backend server 414 at the time the user initiates the interaction. It should be noted that the backend server 414 and the representative software 418, 420 are in communication through an existing or previously established communication channel. The backend server 414 then communicates 416 with the backend representative software 418 for presentation to a backend representative 442. It should also be noted that a cookie 380, may be retrieved from within client 400 and delivered up to backend server 414 and according to the programming of the associated business logic 415, for example, to identify a specific client and for use in indexing any previous interaction history such as within log 413. The resulting data may then be forwarded to representative software 418 for specific use by backend representative 442.

When more than one backend representatives are utilized in a system environment, the request for communication from the user may be broadcast to several backend representatives allowing, for example, the first available backend representative 442, 444 to select the request and take over 430 the communication channel 411 (FIG. 6) with the client 400. A history or log 413 of the interaction(s) between the user and the backend representative may be accumulated 431 which allows the backend representative 442, 444 or the respective representative software 418, 420 to modify interactions with the user based upon previous interactions.

One exemplary application of an embodiment of the present invention includes a web site that has presented thereon a display space in the form of a banner ad. By way of example and not limitation, the banner ad may invite a user to click on the display space presented to engage in conversation with a business representative, an example of which may be a mortgage loan officer, a travel agent, or a technical support specialist. In such an example, the user operating the client will have initiated the interaction with a backend representative. Therefore, once the user selects, for example, a banner ad, a persistent bidirectional communication channel 411 (FIG. 6) is opened between the display space object 136 and the backend server. Once the channel, for example, is opened, the backend representative may note the opening of the channel and respond accordingly.

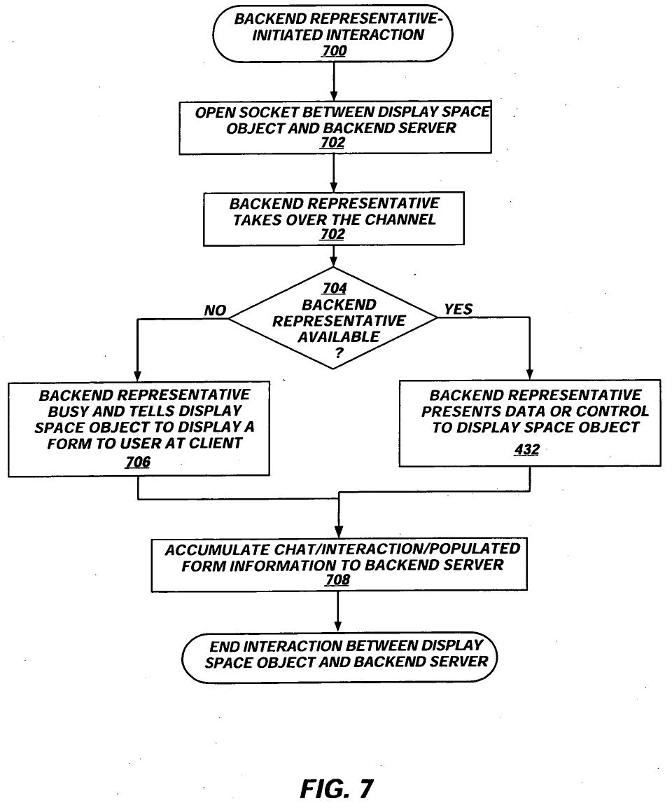

FIG. 7 illustrates interaction initiated by the backend representative, in accordance with an embodiment of the present invention. Description of the backend initiated embodiment of the present invention as described herein also makes further reference to the block diagram of FIG. 6. If interaction is initiated 700 from the backend representative 442, then the process commences in a reverse-initiated communication chat arrangement. By way of example and not limitation, a backend representative 442 may initiate interaction over an open 701 communication channel between the display space object 410 of client 400 and a backend server 414. It should be noted that the backend server 414 and the representative software 418 are in communication through a previously established communication channel.

The representative software 418 may be made aware of the visitor in two ways: (1) the display space object is configured to open the persistent communication channel on its own or upon triggering by the visitor. The triggering in the present embodiment differs from visitor-initiated chat since the visitor is not aware that they are going to be approached for communication, but is otherwise interacting with the display space object for other purposes or reasons; or (2) the display space object is configured to make itself known to the backend server and then to the representative software via, for example, an HTTP or HTTPS request. If the persistent communication channel has already been established (as with approach 1), the representative may use the representative software 418 to initiate communication with the visitor immediately with text, video, audio, graphics, shared whiteboard, or other means. If the communication channel has yet to be established (as with approach 2), the representative indicates to the backend server, through the representative software 418, that a persistent connection is to be established with that particular display space object. That display object, in this case, is configured to check with the backend server 414 at a regular interval to determine if the backend server 414 needs to establish a persistent connection. Once the persistent connection is established, the representative may initiate the communication as previously described. The backend server 414 then communicates with the backend representative software 418 for presentation to a backend representative 442. It should also be noted that a cookie 380 may be retrieved from within client 400 and delivered up to representative software 418, for example, to identify a specific client and for use in indexing any previous interaction history from log 413. Communication that is initiated in this way is intended to provide proactive communication to visitors of a web site, much in the way, for example, that a salesperson might greet and question a potential customer who has entered a store. In some embodiments, there is no interaction required by the visitor in order for the communication to take place, besides having visited the web page on which the display space object resides. The visitor does not have to request to communicate with a representative, and does not have to refresh the page or be taken to another web page for the communication to occur.

The backend representative 442 through representative software 418 takes 702 control of display space object 410 through the persistent communication channel 411 (FIG. 6). Backend representative 442 may control the user's experience by manipulating the display space content, by popping up additional windows displaying information of interest, such as sales promotional information or otherwise, or by re-directing the page to another URL. The channel 411 established by the display space object 410 enables ongoing exchange of information and control between the user via the display space 120 (FIG. 2) as controlled by the display space object 410 and the backend representative 442 via the backend server 414 executing business logic 415 thereon.

A query 704 determines if a backend representative is available for immediate interaction with the user. When a backend representative is available, the backend representative controls 432 the display space object 410 which alters the presentation or behavior of the display space 120 (FIG. 2). Control of the display space object 410 may also allow additional windows to be opened for presentation of information to the user or the client may be redirected to alternative web pages. When a backend representative 442 is unavailable or busy, or desires to gather information from the visitor, the display space object 410 may display 706 form data as opposed to live interactive data to the user via the display space 120 (FIG. 2).

A history or log 413 of the interaction(s) between the user and the backend representative 442 may be accumulated 708 which allows the backend representative 442 or the respective backend software 418 to modify interactions with the user based upon previous sessions. The display space object 410 also has access to the history or log 413 of the interactions in order to be responsive thereto for enabling personalization of the display space 120 (FIG. 2).

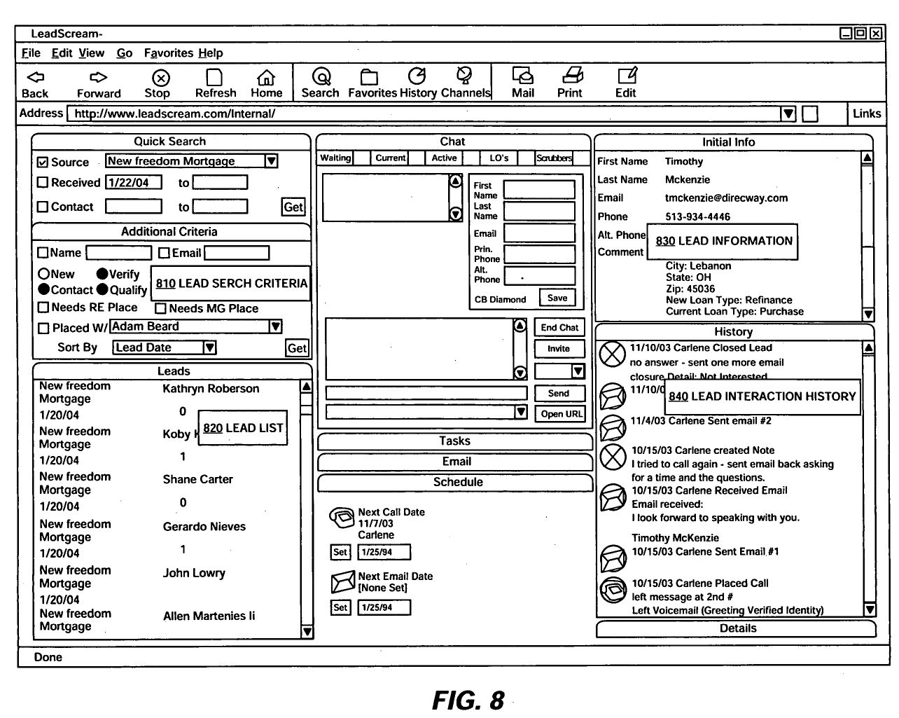

FIG. 8 is a screenshot illustrating the layout of representative software, in accordance to an embodiment of the present invention. The representative software may include several modules that perform functions to facilitate the collection, storage, management, filtering, tracking, reporting, statistical analysis, interaction and communication, follow-up, and conversion of leads. Search criteria 810 are used to filter leads according to various attributes such as source, dates received, follow-up dates, name, email, progression stage, representative assigned, etc., and to produce a list of leads 820. Selecting a particular lead may bring up pertinent information about that person, including their contact information 830 and a history of all interactions with that person 840. The history may be divided into types of tasks such as phone calls made, emails sent, emails received, placement with other representatives, notes made, and transcripts of real-time chat interactions, etc.

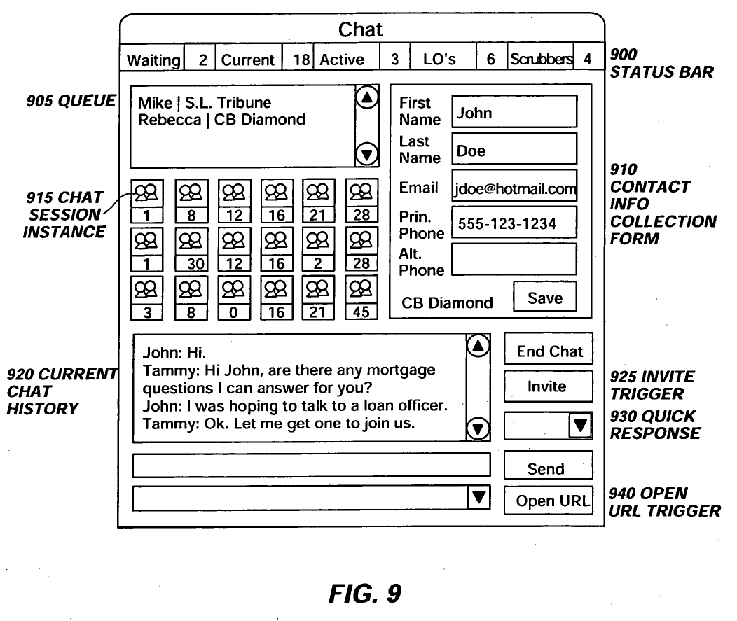

FIG. 9 is a screenshot illustrating the layout of the chat module of the representative software, in accordance to an embodiment of the present invention. The following description applies to this particular embodiment of the present invention, which is geared toward text chat, but could also include functionality for voice chat, video communication, shared whiteboards, etc. The status bar 900 is a reference for various live statistics that are updated in real-time, not requiring page refreshes. The statistics may include information such as how many visitors are in queue waiting to chat, how many current chat sessions the logged-in representative has going, how many are active (i.e., that the visitor has entered text and is awaiting a representative response), and how many representatives of each role are currently logged in, etc. Visitors waiting for a chat session, and/or visitors who may be approached through representative-initiated chat are listed in a queue 905. Which visitors are displayed may depend on the role of the logged-in representative.

Clicking on a visitor in-queue creates a chat session instance 915. The representative may toggle between chat instances and when an instance is selected, the contact info collection form 910 may be populated with any contact information that has been gathered about the user. Such information may be added and updated as it is collected. The source of the lead (e.g., the web site the visitor is viewing) is also tracked. The history of the chat interaction is listed in the current chat history 920, and is logged to the permanent lead history 840 (FIG. 8). The invite trigger 925 is used for escalation and/or de-escalation, to invite another representative in on the chat. Clicking that trigger will cause the active visitor to be listed in the queue of the appropriate representatives (based on role), and it may alert them. There are common blocks of text referenced in the quick response tool 930 that the representative may use to auto-populate the textbox where they type in the text they send. This makes for less typing on the part of the representative. If the representative needs to open up a URL for the visitor, they may do so by selecting it and using the open URL trigger 940.

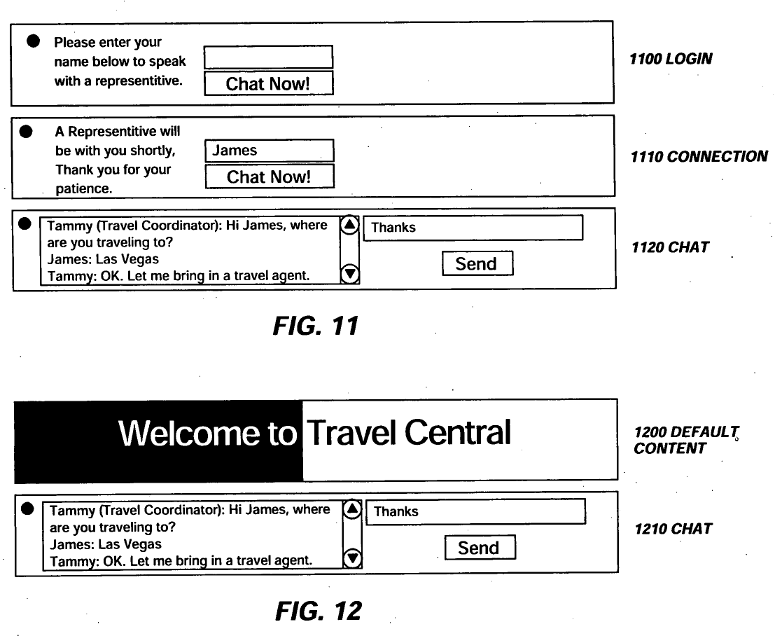

FIG. 11 is a series of screenshots that show the progression of a display space object, in accordance with the present embodiment of the invention, in the form of a banner ad wherein communication is initiated by the visitor. In this embodiment, the visitor is prompted to establish the connection by entering an identifier 1100, which in the present example is illustrated as a name. In another embodiment, the user may click a button, for example, “Chat Now”, and an identifier may be generated automatically, for example, through the backend server. The connection is made 1110, providing that there is a connection socket available and contingent on there being a representative available, and the two-way chat may begin 1120.

In FIG. 12, the screenshot progression illustrates an example of one embodiment where communication is initiated by a representative. Default content 1200 is displayed until the representative decides to trigger a connection to be made through the representative software, at which point the content changes to display the chat 1210 taking place.

Although the foregoing description contains many specifics, these are not to be construed as limiting the scope of the present invention, but merely as providing certain exemplary embodiments. Similarly, other embodiments of the invention may be devised which do not depart from the spirit or scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims are encompassed by the present invention.

1. A method for communicating between a client and a backend server, comprising:
requesting a web page including at least one nondisplay space object and a display space object configured to establish and maintain a persistent communication channel with the backend server;
the display space object connecting with the backend server to form the persistent communication channel;
rendering the web page including a display space and at least one nondisplay space according to the display space object and the at least one nondisplay space object; and
interacting via the persistent communication channel between the display space object and the backend server when initiated by the display space object.

2. The method of claim 1, wherein interacting via the persistent communication channel is according to one of HTTP and HTTPS requests between the display space object and the backend server.

3. The method of claim 1, wherein interacting via the persistent communication channel further comprises interacting between the display space object and socket server software on the backend server.

4. The method of claim 1, further comprising retrieving at least one cookie of interest from the client and transmitting at least a portion of data in the at least one cookie of interest to the backend server via the communication channel.

5. The method of claim 4, further comprising producing a unique identifier of the display space object for storage in the at least one cookie of interest.

6. The method of claim 4, further comprising the display space object dynamically altering data within the display space in response to at least one of the at least one cookie of interest and the backend server.

7. The method of claim 1, wherein the connecting with the backend server comprises connecting with the backend server to form the persistent communication channel when initiated by the display space object in response to interaction within the display space.

8. The method of claim 1, wherein interacting further comprises transmitting data collected from the display space object to the backend server via one of the persistent communication channel and one of HTTP and HTTPS requests.

9. The method of claim 1, wherein interacting further comprises one of periodically transmitting data to and from the display space object to the backend server and the display space object and potentially initiating a connection between the display space object and the backend server.

10. The method of claim 1, further including configuring the persistent communication channel as a secure channel.

11. The method of claim 1, further comprising controlling the display space by a backend representative via the persistent communication channel.

12. The method of claim 1, further comprising accumulating a log of activity between the display space object and the backend server.

13. The method of claim 1, wherein when the interaction is initiated by the display space object in response to the backend server, enabling initiation of communication from the backend server via the persistent communication channel.

14. A system for communicating, comprising:
a client configured to request a web page including at least one nondisplay space object and a display space object, the display space object configured to establish and maintain a persistent communication channel during a session, the client further configured to render the web page including a display space and at least one nondisplay space according to the display space object and the at least one nondisplay space object, respectively;
a backend server coupled to the display space object via the persistent communication channel and configured to notify a backend representative when the persistent communication channel is established with the display space object; and
representative software interactively coupled with the backend server and responsive to notification when the persistent communication channel is established, the representative software further configured to send data to the client via the persistent communication channel for rendering on the display space.

15. The system of claim 14, wherein the client further comprises at least one cookie of interest, and the display space object configured to transmit data from the at least one cookie of interest to the backend server via one of the communication channel and HTTP and HTTPS requests between the display space object and the backend server.

16. The system of claim 14, wherein the backend server further comprises business logic configured to notify the representative software of establishment of the communication channel.

17. The system of claim 16, wherein the business logic further includes logic to determine if the backend representative is available for sending the data to the display space.

18. The system of claim 14, wherein the backend server further comprises a log comprising a history of interaction between the client and the representative software.

19. A method for a representative to approach a user over a network, comprising:
a client requesting a web page including at least one nondisplay space object and a display space object configured to initiate and maintain a communication channel with the backend server;
the display space object establishing and maintaining a communication channel between the client and a backend server accessible to the representative through representative software;
rendering the web page including a display space and at least one nondisplay space according to the display space object and the at least one nondisplay space object; and
interacting via the communication channel between the display space object and the backend server when initiated by one of the display space object responsive to the user and the backend server responsive to the representative.

20. The method of claim 19, wherein the interacting comprises sending data initiated by the backend server in response to the representative to the display space object via the communication channel for rendering by the client in the display space.

21. The method of claim 19, wherein the interacting further includes selecting interaction between one of a plurality of representatives.

22. The method of claim 19, wherein interacting comprises the backend server notifying the representative of establishment of the communication channel and the backend server facilitating data transmission from the representative to the display space at the client.

23. The method of claim 19, further comprising retrieving at least one cookie of interest from the client and transmitting at least a portion of the data in the at least one cookie of interest to the backend server via one of the communication channel and the backend server and forwarding the at least one cookie of interest to the backend server via the communication channel.

24. The method of claim 19, further including configuring the display space as an advertisement on the web page.
